(19) United States
(12) Patent Application Publication
(10) Pub. No.: US 2004/0164022 A1
(43) Pub. Date: Aug. 26, 2004

(54) Reverse osmosis system

(76) Inventor: Donald F. Solomon, Hemet, CA (US)

Correspondence Address: STOUT, UXA, BUYAN & MULLINS LLP, 4 VENTURE, SUITE 300, IRVINE, CA, 92618, US

(21) Appl. No.: 10/373,117

(22) Filed: Feb. 24, 2003

(51) Int. Cl. B01D 65/00

(52) U.S. Cl. 210/637; 210/652; 210/137; 210/321.65; 210/420

(57) ABSTRACT

A reverse osmosis system includes a reverse osmosis filter apparatus in communication with a pressure conversion apparatus. The reverse osmosis filter is connected to a high pressure pump that provides feed water at a high pressure to the reverse osmosis filter. The pressure conversion apparatus is in communication with a low pressure water supply and the reverse osmosis filter apparatus. The pressure conversion apparatus receives low pressure water from the low pressure water supply and high pressure brine from the reverse osmosis filter apparatus. The pressure conversion apparatus is structured to convert the low pressure water contained in the pressure conversion apparatus to high pressure water without separately generating forces on the low pressure water. Methods of filtering water are also disclosed.

### FIELD OF THE INVENTION

The invention relates to systems and methods for filtering water. More particularly, the invention relates to systems and methods for filtering water in which a volume of high pressure water generated by a high pressure pump is passed through a reverse osmosis filter, and a volume of low pressure water is converted to a pressure substantially equal to the pressure of the volume of high pressure water without passing the water through the high pressure pump or otherwise separately generating forces on the low pressure water.

### BACKGROUND

Desalination is a process used to reduce the dissolved salt content of saline water to usable levels. Desalination processes involve three liquid streams: the saline feed water, which may be brackish water or seawater, low salinity product water (the permeate or filtered output water), and a very saline concentrate (brine). Saline feed water may be drawn from a water supply, such as the ocean, a holding tank of a well system, or a city water supply, among other things.

In reverse osmosis systems used to desalinate water, the major energy requirement is for the initial pressurization of the feed water. For example, in brackish water desalination, the operating pressures may range from about 250-400 psi, and for seawater desalination, the operating pressures may range from about 800-1000 psi. A substantial amount of energy is lost is existing systems due to inefficiencies in handling the brine that is generated from the reverse osmosis filters.

One type of system is disclosed in U.S. Pat. No. 6,470,683 to Childs et al. The system disclosed therein includes a fluid displacement unit that includes two cylinders that receive low pressure water from a water supply, and high pressure brine from a reverse osmosis filter. Importantly, the system disclosed in Childs requires a separate hydraulic pump mechanically coupled to the pistons contained in the cylinders of the fluid displacement unit via a separate shaft. The separate hydraulic pump causes movement of the pistons within the cylinders to compress low pressure water contained in the cylinders and force it through a check valve before passing through the reverse osmosis filter. The compression of the low pressure water is necessary to increase the pressure of the water flowing to the reverse osmosis filter. The system disclosed by Childs is relatively complicated and requires a precise interplay between the separate hydraulic pump and the fluid displacement unit in order to achieve the desired operation of the system.

Thus, there remains a need in the art for reverse osmosis systems that are relatively simple to manufacture, operate, and maintain, and that reduce the amount of energy lost due to the reverse osmosis processing of water.

### SUMMARY

A reverse osmosis system and methods are disclosed that are energy efficient and simple to practice. In one aspect, a reverse osmosis system includes a reverse osmosis filter apparatus and a pressure conversion apparatus in fluid communication with each other. The reverse osmosis filter apparatus receives high pressure water and filters the high pressure water to produce filtered product water and high pressure brine. The high pressure brine flows through one or more conduits to the pressure conversion apparatus. The pressure conversion apparatus also receives low pressure water from a low pressure water supply. The pressure conversion apparatus is structured to convert the low pressure water to a pressure substantially equal to the pressure of water flowing to the reverse osmosis filter apparatus without separately generating forces on the low pressure water, or compressing the low pressure water.

In one embodiment, the pressure conversion apparatus includes one or more pairs of containers for containing the brine and the low pressure water. The pressure conversion apparatus is coupled to the reverse osmosis filter apparatus to direct water to the reverse osmosis filter without causing the water to flow through a high pressure pump before being delivered to the reverse osmosis filter apparatus. The pressure conversion apparatus may receive low pressure water from a water supply from which the high pressure pump receives water, or it may receive low pressure water from a different water supply. The reverse osmosis system, in certain embodiments, includes a valve assembly, which may include one or more valves in one or more discrete units, that is positioned in the system to control the flow of brine and/or low pressure water to the containers of the pressure conversion unit so that the brine and the low pressure water do not flow into the same container at the same time.

In one embodiment, the pressure conversion apparatus of a reverse osmosis system, includes at least one pair of first and second containers. Each container of the apparatus has a piston disposed therein defining a first chamber and a second chamber on either side of the piston. Each of the first and second containers include a brine inlet port located on the first chamber of each container to receive brine from the reverse osmosis filter, a brine outlet port located on the first chamber to direct brine from the containers, a low pressure water inlet port located on the second chamber of each container to receive water from a water supply with water at a pressure lower than the pressure of water created by the high pressure pump, and a high pressure fluid outlet port located on the second chamber of each container to direct the water in the second chamber to the feed water inlet conduit at substantially the same pressure of the water directed to the reverse osmosis filter apparatus. The pressure conversion apparatus also includes at least one valve assembly positioned in the system to control the flow of fluid through the containers so that the low pressure water contained in the second chamber of each container is converted to a pressure substantially equal to the pressure of water in the feed water inlet conduit independently of moving the pistons in the containers.

In one embodiment, the pistons of the pressure conversion apparatus each have a surface in each of the first and second chambers of the container where the surface in the first chamber has a greater area than the surface in the second chamber. In another embodiment, the pistons have equal surface areas. In such embodiments, the system includes one or more booster pumps that increase the pressure of the low pressure water to create a pressure differential between the first and second chambers of a container.

The valve assembly of the foregoing systems may include a plurality of gate valves and/or check valves. Certain embodiments of the foregoing systems also include a water accumulator positioned downstream from the high pressure pump and upstream of the reverse osmosis filter. The accumulator accommodates pressure fluctuations of the water in the system. The foregoing systems may also include one or more flow control devices which are operative to control the amount of permeate produced by the reverse osmosis filter apparatus. The flow control devices are located in the system to control the rate in which the pistons move in the containers of the pressure conversion apparatus. In certain embodiments, the flow control device is a needle valve disposed on a brine outlet conduit. In other embodiments, the flow control device may be a pump that changes the pressure of low pressure water in the pressure conversion apparatus. The pistons of the foregoing system are preferably mechanically coupled together so that movement of one piston causes a corresponding movement of another piston. In certain embodiments, the pistons are coupled together by one or more shafts extending between the pistons. The foregoing systems may also include one or more switching assemblies to control the valves of the system. In certain embodiments, the switching assemblies include a switch that is actuated by the movement of one or more of the pistons of the pressure conversion apparatus.

In accordance with the disclosure herein, a method for filtering water in a reverse osmosis system, comprises the steps of: (a) directing high pressure water to a reverse osmosis filter apparatus to produce filtered product water and brine; (b) directing the brine from the reverse osmosis filter apparatus to a pressure conversion apparatus; (c) directing low pressure water to the pressure conversion apparatus in a manner that the low pressure water does not mix with the brine; and (d) actuating at least one valve in the reverse osmosis system so that the low pressure water contained in the pressure conversion apparatus is converted to a pressure substantially equal to the high pressure water of step (a) without separately generating a force or forces on the low pressure water.

Any feature or combination of features described herein are included within the scope of the present invention provided that the features included in any such combination are not mutually inconsistent as will be apparent from the context, this specification, and the knowledge of one of ordinary skill in the art.

Additional advantages and aspects of the present invention are apparent in the following detailed description.

### BRIEF DESCRIPTION OF THE FIGURES

FIG. 1A is a schematic of a reverse osmosis system having one pressure conversion unit that improves the efficiency of the filtering of the water passing through the system. In FIG. 1A, the pistons are moving to the right.

FIG. 1B is a schematic of the reverse osmosis system of FIG. 1A in which all of the valves are in a closed position, and the pistons are not moving.

FIG. 1C is a schematic of the reverse osmosis system of FIG. 1A in which the valves have switched their status from open to closed, and the pistons are moving to the left.

FIG. 2A is a schematic of a reverse osmosis system having one pressure conversion unit that improves the efficiency of the filtering of the water passing through the system. In FIG. 2A, the pistons are moving to the right.

FIG. 2B is a schematic of the reverse osmosis system of FIG. 2A in which all of the valves are in a closed position, and the pistons are not moving.

FIG. 2C is a schematic of the reverse osmosis system of FIG. 2A in which the valves have switched their status from open to closed, and the pistons are moving to the left.

FIG. 3A is a schematic of a reverse osmosis system having one pressure conversion unit that improves the efficiency of the filtering of the water passing through the system. In FIG. 3A, the pistons are moving to the right.

FIG. 3B is a schematic of the reverse osmosis system of FIG. 3A in which the valves have switched their status from open to closed, and the pistons are moving to the left.

### DETAILED DESCRIPTION

A reverse osmosis system in accordance with the invention disclosed herein includes a reverse osmosis filter and a pressure conversion apparatus. The pressure conversion apparatus is configured to receive high pressure brine from the reverse osmosis filter and to receive water from a low pressure water supply. As used herein, terms such as “high” and “low” are used relative to each other. For example, the low pressure water supply has a water pressure that is lower than the pressure of the brine from the reverse osmosis filter. Similarly, the low pressure water supply has a water pressure that is lower than the pressure of water provided by a high pressure water pump, as described herein. Examples of low pressures may range from about 10 psi to about 50 psi, but are not limited thereto. Examples of high pressures may range from about 250 psi to about 400 psi, or even greater, for example, from about 800 psi to about 1200 psi. These values are provided only for the purposes of illustration, and other values could be used for the various low and high pressures. In addition, directional terms, such as, top, bottom, left, right, above, below, upstream, and downstream, are used in context to the accompanying drawings, and in no way should be used to limit the scope of the invention. The pressure conversion apparatus is configured to increase the pressure of the water received from the low pressure water supply, so that the pressure of the water contained in the pressure conversion apparatus is substantially equal to the pressure of the water directed to the reverse osmosis filter from a high pressure pump. The pressure conversion unit is structured to convert the low pressure water to a high pressure without separately generating pressure on the low pressure water. For example, the low pressure water is converted to a high pressure water by switching one or more valves so that the low pressure water contained in the pressure conversion apparatus is in fluid communication with the high pressure water flowing to the reverse osmosis filter. Advantageously, the conversion from low pressure to high pressure occurs without compressing the water contained in the pressure conversion apparatus. In the systems of the present invention, the conversion from low pressure to high pressure is accomplished by establishing an equilibrium between the high pressure water and the low pressure water by switching one or more valves located on the various conduits, as described herein. Thus, the systems and methods disclosed herein provide enhanced energy recovery, and are much simpler to make, operate, and maintain compared to current reverse osmosis systems.

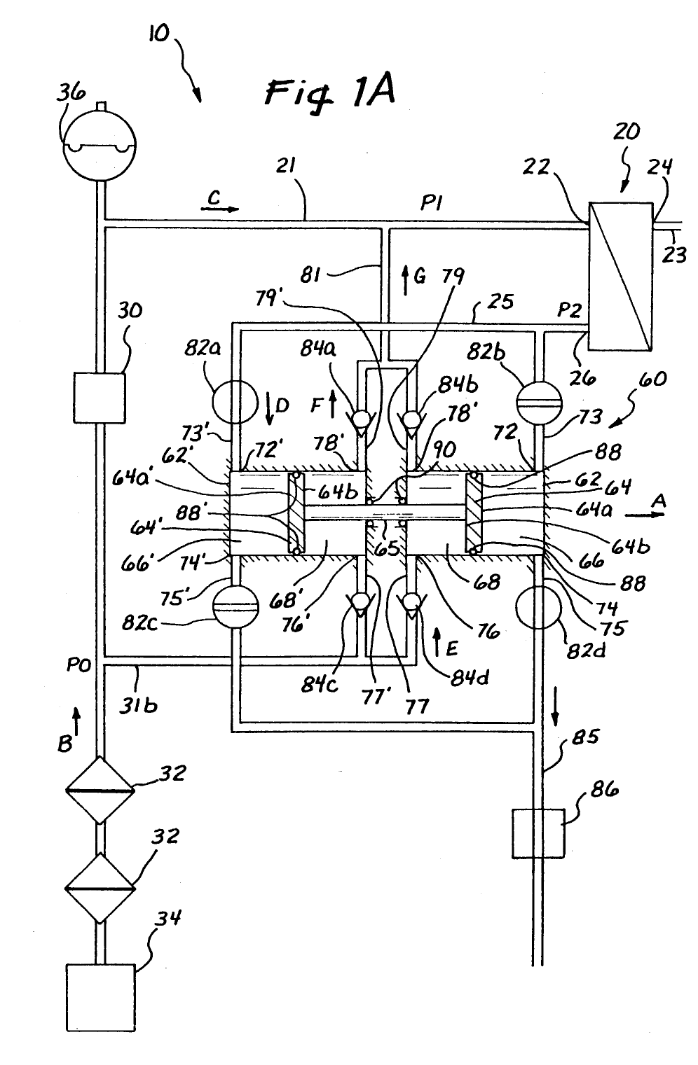

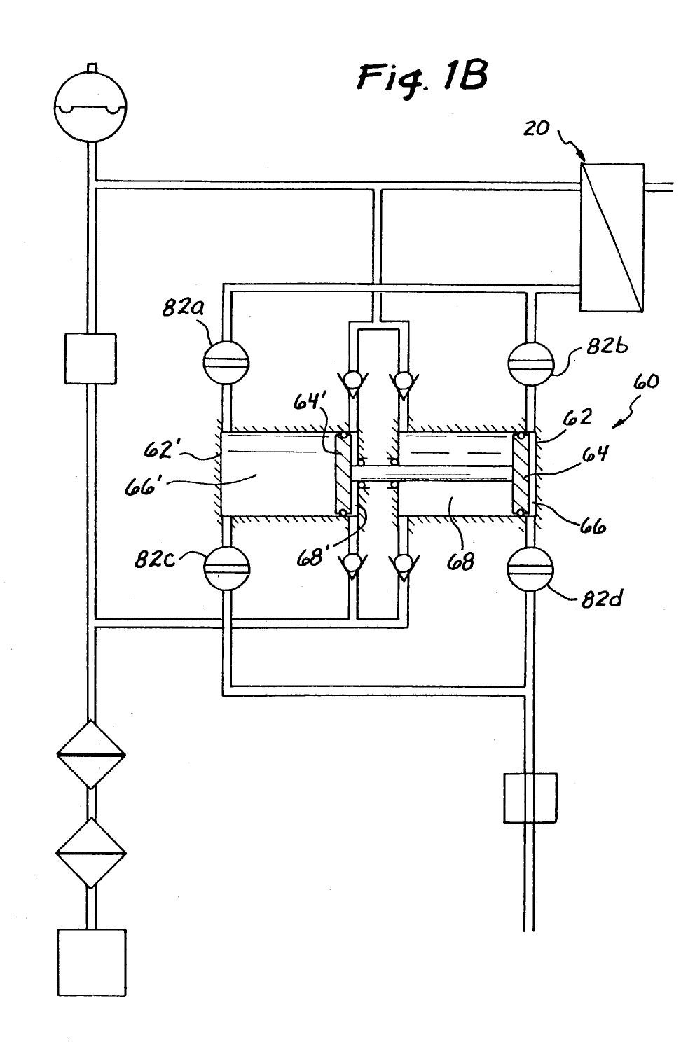

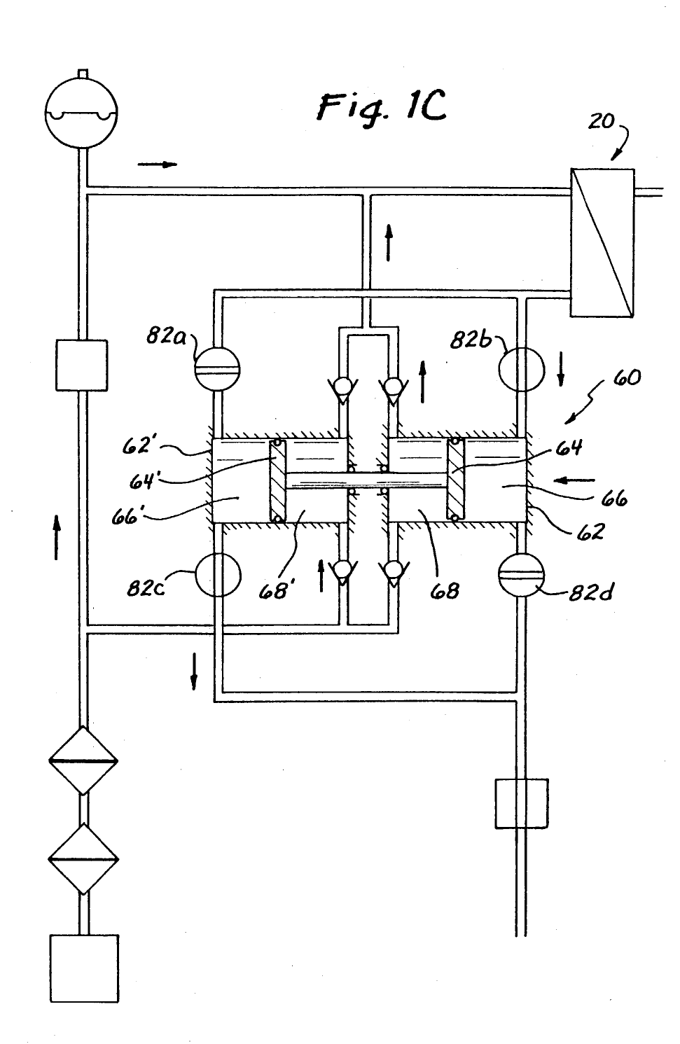

Referring to the figures, and specifically FIG. 1A, a reverse osmosis system 10 includes a reverse osmosis filter apparatus 20 and a pressure conversion apparatus 60. Reverse osmosis filter apparatus 20 includes an inlet port 22, a permeate or filtered water outlet port 24, and a brine outlet port 26. Inlet port 22 is connectible to a high pressure pump 30 via feed water inlet conduit 21. The permeate flows from reverse osmosis filter apparatus 20 via a permeate outlet conduit 23 that is connected to permeate outlet port 22. Brine flows from reverse osmosis filter apparatus 20 to pressure conversion apparatus 60 via brine outlet conduit 25 that is connected to brine outlet port 26.

High pressure pump 30 receives low pressure water (e.g., water having a pressure that is less than the pressure created by the high pressure pump) from a low pressure water supply 34 (such as an ocean, a salty body of water, a holding tank of a well system, or a city water supply) via a low pressure water conduit 31a. High pressure pump 30 supplies feed water to reverse osmosis filter apparatus 20 at a flow rate equal to the permeate production rate. One or more filters 32 may be provided in the system to pre-filter the water before it passes to reverse osmosis filter apparatus 20. As illustrated in FIG. 1A-1C, two filters 32 are provided on low pressure water conduit 31a. One of these filters may be a particulate filter that is structured to remove particulate matter from water flowing through conduit 31a. The other filter may be a carbon filter. In addition, one or more filters, such as the carbon filter, may be provided downstream of high pressure pump 30 (e.g., located downstream of high pressure pump 30 and upstream of reverse osmosis filter apparatus 20). Furthermore, more or fewer filters could also be provided in the system. Low pressure water also flows through low pressure water conduit 31b to pressure conversion apparatus 60, as described herein. An accumulator 36 is also illustrated in the accompanying figures. Accumulator 36 is located downstream of high pressure pump 30 and upstream of reverse osmosis filter apparatus 20. Accumulator 36 is located to receive water from high pressure pump 30 and water present in feed water inlet conduit 21. Accumulator 36 is operative to accommodate for pressure fluctuations of the water in reverse osmosis system 10, which may be caused by the operation of pressure conversion apparatus 60, for example. Accumulator 36 accommodates for pressure fluctuations that may be caused by the switching of the valves of the system. Among other things, this permits the valves to switch at full recirculating flow of water without experiencing significant pressure fluctuations.

Pressure conversion apparatus 60 is illustrated as including two containers 62, 62′ each container having a piston 64, 64′ disposed in the respective container 62, 62′. Although in the illustrated embodiment, containers 62 and 62′ are cylinders, any suitable geometry may be used in the manufacture of the containers. In addition, although the illustrated embodiment is shown with two containers 62, 62′, or one pair of containers, additional embodiments may include two or more pairs of containers. Preferably, when two or more pairs of containers are provided, the pairs of containers are arranged in parallel to facilitate efficient filtering of water through the reverse osmosis system. Pistons 64 and 64′ are mechanically coupled to each other so that movement of one piston causes a corresponding movement of the other piston. In the embodiment illustrated in FIGS. 1A-1C, pistons 64 and 64′ are mechanically coupled via shaft 65. In this embodiment, shaft 65 is a single element fixedly secured to pistons 64 and 64′. In other embodiments, pistons 64 and 64′ may be coupled by two or more shafts substantially abutting one another so that movement of one piston causes a corresponding movement of the other piston.

Referring to container 62, piston 64 is located in container 62 and defines a first chamber 66 and a second chamber 68 located on either side of piston 64. Chambers 66 and 68 are structured to contain volumes of water, as disclosed herein. As piston 64 moves within container 62, the volume of first chamber 66 and second chamber 68 increases or decreases depending on the direction in which piston 64 moves. Similarly, container 62′ includes piston 64′ disposed therein to define a first chamber 66′ and a second chamber 68′ disposed on either side of piston 64′ and structured to contain volumes of water. First chambers 66, 66′ include brine inlet ports 72, 72′, respectively. Brine inlet ports 72, 72′ are connectible to brine outlet conduit 25 via brine inlet conduit 73, 73′, respectively. First chambers 66, 66′ also include brine outlet ports 74, 74′, respectively. Brine outlet ports 74, 74′ are connectible to a brine-to-drain conduit 85 via one or more brine outlet conduits 75, 75′, respectively. Second chambers 68, 68′ include one or more low pressure water inlet ports 76, 76′ to receive low pressure water from a low pressure water supply, such as water supply 34, via low pressure water inlet conduits 77, 77′, respectively. In the illustrated embodiment, low pressure water inlet conduits 77, 77′ receive water from low pressure water conduit 31b. Second chambers 68, 68′ also include one or more high pressure water outlet ports 78, 78′, respectively. As discussed herein, the volume of low pressure water contained in either second chamber 68 or 68′ is converted to a high pressure by the actuation of one or more valves. Thus, outlet ports 78, 78′ pass high pressure water from pressure conversion apparatus 60. High pressure water outlet ports 78, 78′ direct high pressure water to feed water inlet conduit 21 via one or more high pressure water outlet conduits 79, 79′ respectively.

To control the flow of water through pressure conversion apparatus 60 and the various conduits, one or more valves are provided. In certain embodiments, the valves are provided in a single valve assembly comprising multiple individual valves. In other embodiments, single valves are used on each conduit, and each of the valves are independently controlled and/or actuated. Referring to the embodiment illustrated in FIGS. 1A-1C, a plurality of gate valves 82a, 82b, 82c, and 82d are provided on the brine inlet conduits and brine outlet conduits. Referring to FIG. 1A, gate valve 82a and gate valve 82d are in the “open” position, and gate valve 82b and gate valve 82c are in the “closed” position. Reverse osmosis system 10 also includes a plurality of check valves (e.g., one-way valves) 84a, 84b, 84c, and 84d located on the low pressure water inlet conduits and the high pressure water outlet conduits. In particular, check valve 84a is provided on high pressure water outlet conduit 79′, check valve 84b is provided on high pressure water outlet conduit 79, check valve 84c is provided on low pressure water inlet conduit 77′, and check valve 84d is provided on low pressure water inlet conduit 77. As illustrated in FIGS. 1A-1C, check valves 84a-84d are oriented to provide a unidirectional flow of water from the low pressure water conduit 31b towards the high pressure feed water inlet conduit 21. Thus, the valves of the system are positioned in the system to control the flow of brine and low pressure water into the containers of the pressure conversion apparatus, and are configured so that the brine and the low pressure water do not flow into the same container at the same time.

Each of the brine outlet conduits 75, 75′ are illustrated as joining into a single brine-to-drain conduit 85. These outlet conduits may include one or more flow control devices 86 located along the conduit to control the flow of brine to drain. In the illustrated embodiments, one flow control device 86 is provided on brine-to-drain conduit 85. Providing a flow control device on brine-to-drain conduit 85 permits the rate of the movement of the pistons to be controlled, thereby providing control of the recovery ratio of permeate through the reverse osmosis filter apparatus. Any suitable flow control device may be utilized so long as the device is capable of regulating the rate of movement of the pistons, or the frequency of the piston strokes. In one embodiment, flow control device 86 is a needle valve.

Referring back to containers 62, 62′, pistons 64, 64′ each include a piston seal 88, 88′, respectively. Piston seals 88, 88′ are located around a peripheral edge of the pistons to create a seal between the piston and the side of the container in which the piston is located. In one embodiment, piston seals 88, 88′ are O-rings that are able to withstand the pressures and forces acting on the pistons. In addition, a shaft seal 90 is provided around shaft 65.

In operation, and referring to FIG. 1A, the pistons 64, 64′ are moving to the right, as indicated by arrow A. The movement to the right is achieved by passing low pressure water at a pressure P0 along low pressure water conduits 31a and 31b, as identified by arrow B. When the low pressure water passes through high pressure pump 30, the water→s pressure is increased to pressure P1, and it flows to reverse osmosis filter apparatus 20, as indicated by arrow C. After passing through reverse osmosis filter apparatus 20, brine flows out of brine outlet port 26 at a pressure P2. Pressure P2 is slightly less than pressure P1, but is substantially greater than pressure P0. For purposes of this disclosure, and by way of example, and not by way of limitation, P0 may be about 15 pounds per square inch (psi), P1 may be about 1000 psi, and P2 may be about 990 psi. Thus, both the water in feed water conduit 21 and the brine in brine outlet conduit 25 are at high pressures. Because valve 82a is in the “open” position, high pressure brine flows into first chamber 66′ (as indicated by arrow D), and does not flow out of chamber 66′ because valve 82c is in the “closed” position. As shown in FIG. 1A, both pistons 64 and 64′ include a major surface 64a and 64a′, respectively, and a minor surface 64b and 64b′, respectively. The area of major surface 64a or 64a′ is greater than the area of minor surface 64b or 64b′, respectively. The difference in surface area is evident because shaft 65 is attached to minor surfaces 64b and 64b′. Chamber 68′ contains high pressure water at a pressure substantially equal to the pressure of the water contained in feed water inlet conduit 21 (i.e., substantially equal to P1). The conversion from low pressure water to the high pressure water in chamber 68′ will be discussed herein. Because the pressure of water in chamber 66′ is substantially equal to the pressure of water in chamber 68′, the pressures on either side of piston 64′ are balanced. Advantageously, the balanced pressures help reduce wear on piston seal 88′. More specifically, the small pressure differential across the pistons contributes to the seal fife and helps maintain a low friction, which helps reduce the energy required to operate the pressure conversion unit. However, because surface 64a′ has a greater surface area than surface 64b′, the force acting on surface 64a′ is greater than the force acting on surface 64b′. The greater force causes piston 64′ to move to the right, and to direct the high pressure water in chamber 68′ into high pressure water outlet conduit 79′ and to feed water inlet conduit 21 (as indicated by arrow F). Simultaneously, the movement of piston 64′ causes a corresponding movement of piston 64 in container 62. Because valve 82d is in the “open” position, brine that was contained in chamber 66 of container 62 is directed to drain at atmospheric pressure. As piston 64 moves to the right, negative pressure is created in chamber 68 which causes low pressure water to be directed into chamber 68 from low pressure water conduit 31b (as indicated by arrow E).

As shown in FIG. 1B, pistons 64 and 64′ have completed their stroke by moving substantially to the end of containers 62 and 62′, respectively. In this state, valves 82a and 82d have been switched to a “closed” position so that all of the valves 82a, 82b, 82c, and 82d are in a “closed” position. In this position, there is no flow of fluid through pressure conversion apparatus 60.

As shown in FIG. 1C, valves 82b and 82c are switched to an “open” position. Valve 82b in its open state permits high pressure brine to flow through brine inlet port 72 into chamber 66, and valve 82c in its open state permits the brine contained in chamber 66′ (that filled chamber 66′ during the step of FIG. 1A) to be directed to drain via brine outlet conduit 75′. Because the force on surface 64a is greater than the force on surface 64b, piston 64 moves to the left, as shown in FIG. 1C, and low pressure water that was contained in chamber 68 that has been converted to a high pressure substantially equal to pressure P1 is directed to feed water inlet conduit 21. The switching of the valves and the resulting movement of the pistons is performed as long as desired until a desired amount of permeate or filtered water is generated by reverse osmosis filter apparatus 20.

Advantageously, the configurations of the systems disclosed herein provide a substantially instant conversion of low pressure water contained in chambers 68 and 68′ to high pressure water. This conversion is obtained by the switching of the valves, as described hereinabove, and by the nearly instantaneous equalization in fluid pressure between high pressure water conduit 81 and high pressure water conduits 79 and 79′. This is in contrast to the system disclosed in U.S. Pat. No. 6,470,683, which discloses a pressure conversion of low pressure water to high pressure water only by the separate generation of force on the volume of low pressure water induced by a separate hydraulic pump. The reverse osmosis system of the present invention achieves the desired pressure conversion without a separate pump, without separately generating forces on the low pressure water, and without compressing the low pressure water contained in the container. In other words, the conversion of low pressure water to high pressure water is achieved independently of the movement of the pistons within the containers.

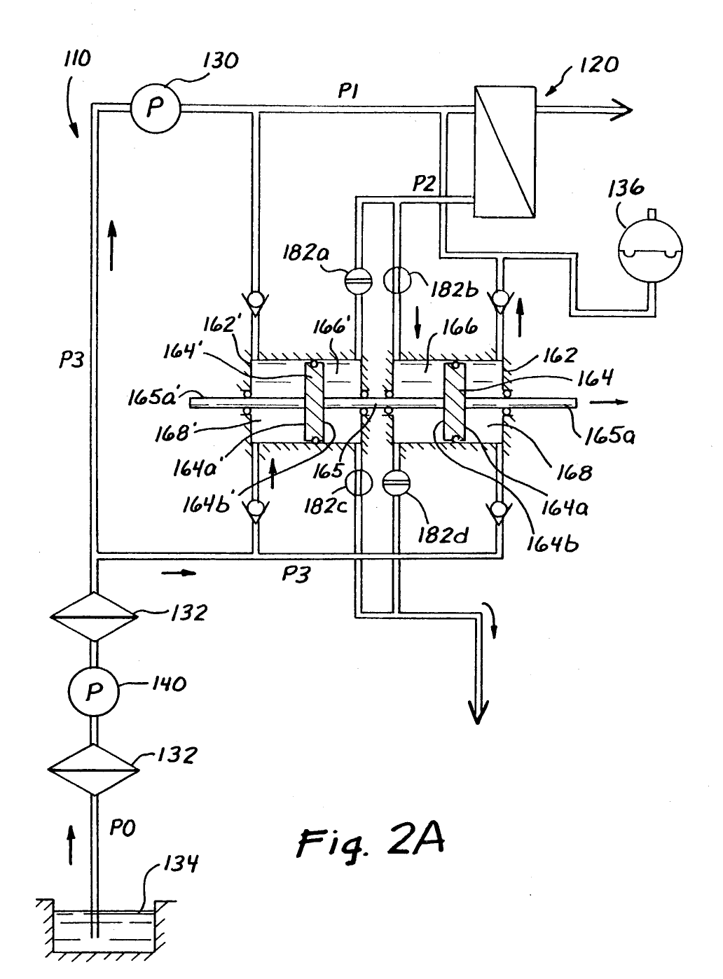

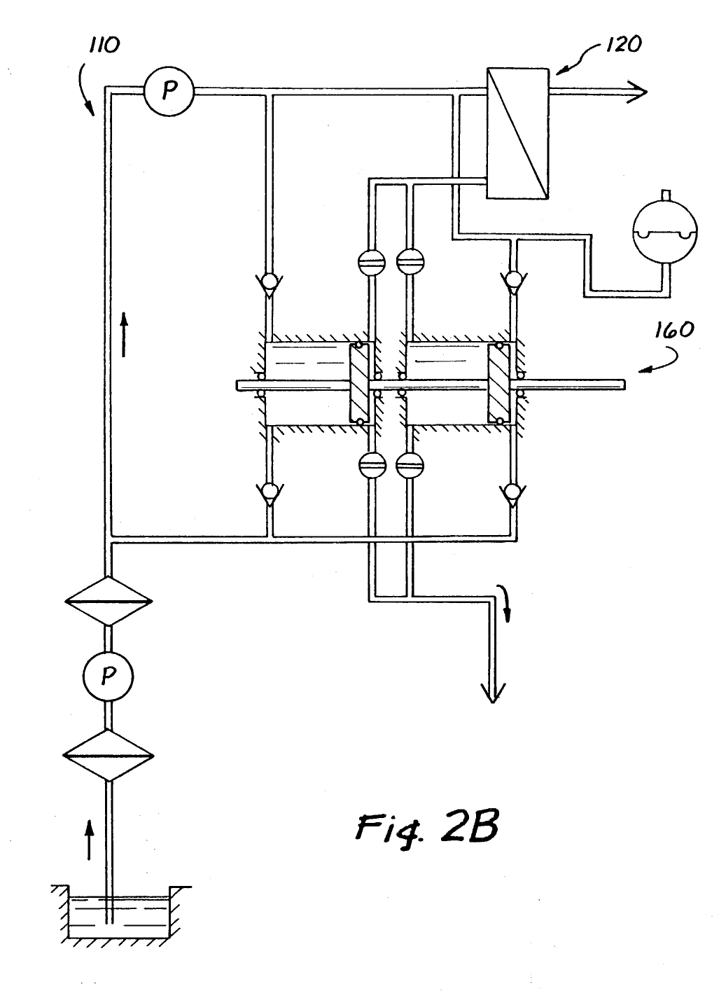

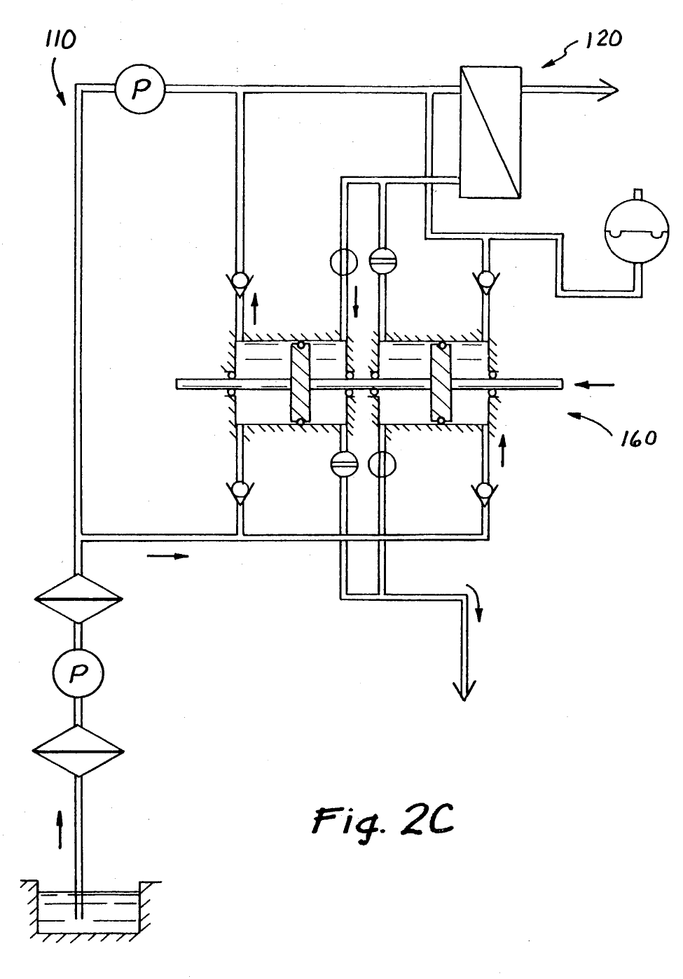

Referring to FIGS. 2A-2C, another reverse osmosis system in accordance with the invention is illustrated. The reverse osmosis system of FIGS. 2A-2C is similar to the reverse osmosis system of FIGS. 1A-1C where like parts are identified by like numbers increased by 100. For example, reverse osmosis system 110 includes a reverse osmosis filter apparatus 120 and a pressure conversion apparatus 160. Reverse osmosis system 110 is similar to reverse osmosis system 10 except for the inclusion of an additional pump 140 that increases the pressure of water received from water supply 134 to an intermediate value P3 between P0 (the pressure of water at in water supply 134) and P1 (the pressure of water created by high pressure pump 130). Thus, referring to the embodiment illustrated in FIGS. 2A-2C, P1-P2>>P3>P0. Pump 140 may be a feed water and circulating pump. Pump 140 is provided to increase the pressure of water in one of the chambers 168 or 168′ at the end of a stroke of the pistons 164 or 164′. Pump 140 is a low energy requiring pump that increases the pressure of the water by an amount effective to create a pressure differential on either side of the pistons. The pressure differential is desirable in this embodiment because the surface area of each of the surfaces 164a and 164b, and 164a′ and 164b′ of the pistons are substantially equal due to the inclusion of an additional shaft 165a and 165a′ on pistons 164 and 164′, respectively. The differential pressure created by high pressure pump 130 is equal to the difference of the feed water pressure to reverse osmosis filter apparatus 120 and booster pump 140. Similar to the reverse osmosis system of FIGS. 1A-1C, reverse osmosis system 110 is structured to nearly instantaneously convert low pressure water received from a low pressure water supply to a high pressure without separately generating forces on water, or independently of separate pump used to move the pistons to compress the low pressure water contained in the containers.

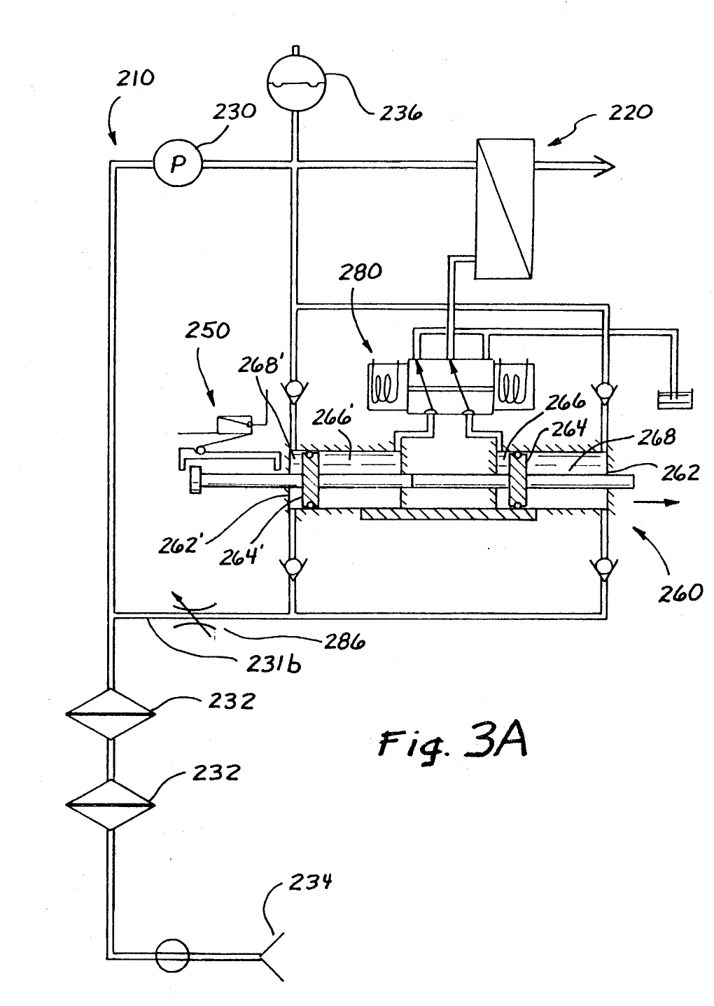

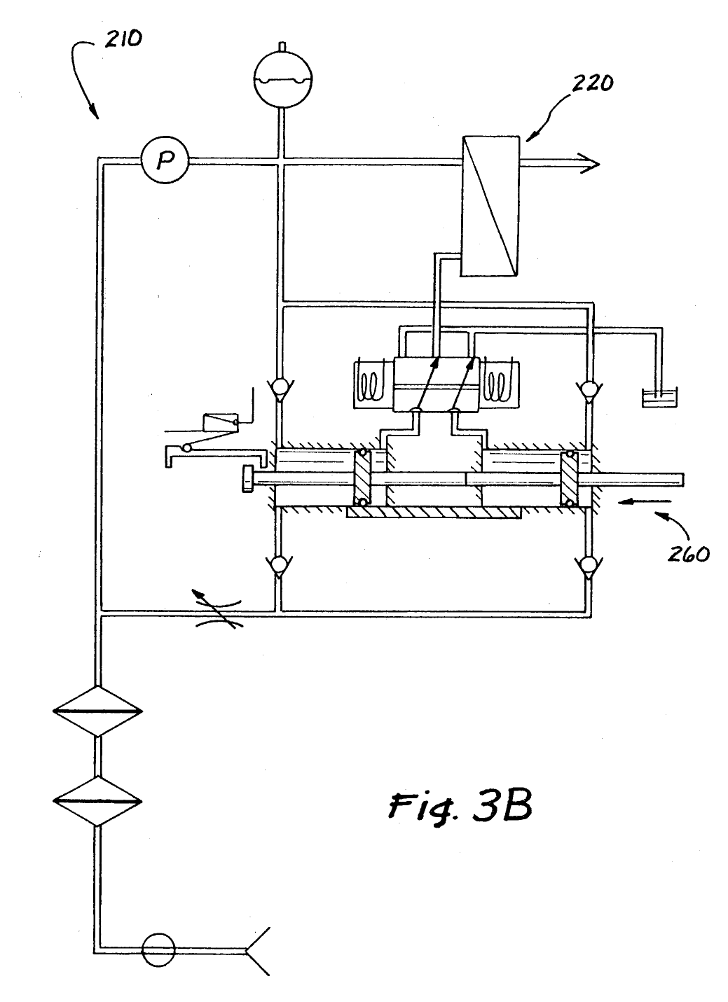

FIGS. 3A-3B illustrate another reverse osmosis system in accordance with the invention herein disclosed. The embodiment illustrated in FIGS. 3A-3B is similar to the embodiment illustrated in FIGS. 1A-1C where like parts are referenced by like numbers increased by 200. One difference between reverse osmosis system 210 and reverse osmosis system 110 is the inclusion of a switch assembly 250. Switch assembly 250 is structured to be actuated by the movement of the pistons within the containers of the pressure conversion apparatus. Switch assembly 250 is operatively coupled to valve assembly 280 to control the position of the valve assembly 280 depending on the position of the pistons in the container. For example, as illustrated in FIG. 3A, brine is directed into chamber 266 through valve assembly 280 causing piston 264 to move to the right. As piston 264 moves to the right, piston 264′ also moves to the right displacing brine contained in chamber 266′ through valve assembly 280 to drain. At the end of the pistons' stroke, switch assembly 250 is actuated to redirect the flow of water through valve assembly 280. Subsequently, as shown in FIG. 3B, brine is directed to chamber 266′ and is displaced from chamber 266 to drain. Thus, the valves of the reverse osmosis system are automatically controlled, as illustrated in this embodiment. Valves of other reverse osmosis systems could be actuated by magnetic detection or a cam driven by an electric screw, for example. Similar to the other embodiments described hereinabove, reverse osmosis system 210 is structured to convert low pressure water to high pressure without separately generating forces on the low pressure water, or independent of any additional pump.

Another advantage achieved with the present invention is the ability to control the amount of permeate produced by the reverse osmosis filter apparatus. In other words, the reverse osmosis system provides a dynamic recovery ratio of permeate to feed water, which can be adjusted in response to changing feed water quality, or the need to modify the quality of the permeate, among other things. The dynamic recovery ratio is obtained, at least in part, by providing one or more flow control devices in the system. The flow control devices are structured and positioned to control the rate at which the pistons move in their containers. For example, as illustrated in FIG. 1A, flow control device 86 is located on the brine-to-drain conduit. In the embodiment illustrated in FIG. 3A, flow control device 286 is located on low pressure water conduit 231b. The flow control device can be located anywhere in the system so long as it is capable of controlling the rate at which the pistons move. For example, a booster pump, such as pump 140 illustrated in FIG. 2A, may be used to vary the frequency of the piston strokes by changing the rate at which the pressure changes in the low pressure water conduits.

Another advantage of the present invention is that the system is manufactured from conventional products. The use of stock products in manufacturing a simple system, such as that disclosed herein, substantially reduces the costs and labor needed to make reverse osmosis systems.

While this invention has been described with respect to various specific examples and embodiments, it is to be understood that the invention is not limited thereto and other embodiments are within the scope of the invention.

What is claimed is:

1. A reverse osmosis system, comprising:
(a) a reverse osmosis filter apparatus having an inlet port connectible to a high pressure pump via a feed water inlet conduit, the high pressure pump receiving water from a water supply, a permeate outlet port for filtered product water, and a brine outlet port for brine; and
(b) a pressure conversion apparatus including a plurality of containers in fluid communication with the reverse osmosis filter to receive brine from the reverse osmosis filter, and in fluid communication with a low pressure water supply providing water at a pressure less than the pressure created by the high pressure pump, the brine and the low pressure water separately contained in the plurality of containers, the pressure conversion apparatus structured to convert the pressure of the low pressure water contained in one of the containers to a pressure substantially equal to the pressure of water in the feed water inlet conduit without compressing the low pressure water contained within the container.

2. The system of claim 1, wherein the pressure conversion apparatus is coupled to the reverse osmosis filter apparatus to direct water to the reverse osmosis filter apparatus without causing the water to flow through a high pressure pump prior to being delivered to the reverse osmosis filter apparatus.

3. The system of claim 1, wherein the pressure conversion apparatus is in fluid communication with the water supply from which the high pressure pump receives water.

4. The system of claim 1, comprising at least one pair of containers.

5. The system of claim 1, comprising a valve assembly positioned in the system to control the flow of brine or the low pressure water to the containers, and configured so that the brine and the low pressure water do not flow into the same container at the same time.

6. A reverse osmosis system, comprising:
(a) a reverse osmosis filter apparatus having an inlet port connectible to a high pressure pump via a feed water inlet conduit, the high pressure pump receiving water from a water supply, a permeate outlet port for filtered product water, and a brine outlet port for brine; and
(b) a pressure conversion apparatus in fluid communication with the reverse osmosis filter apparatus, the pressure conversion apparatus including
(i) at least one pair of first and second containers, each container having a piston disposed therein to define a first chamber and a second chamber on either side of the piston, each of the first and second containers including a brine inlet port located on the first chamber of each container to receive brine from the reverse osmosis filter, a brine outlet port located on the first chamber to direct brine from the containers, a low pressure water inlet port located on the second chamber of each container to receive water from a water supply with water at a pressure lower than the pressure of water created by the high pressure pump, and a high pressure fluid outlet port located on the second chamber of each container to direct the water in the second chamber to the feed water inlet conduit at substantially the same pressure of the water contained in the feed water inlet conduit; and
(ii) at least one valve assembly positioned in the system to control the flow of fluid through the containers so that the low pressure water contained in the second chamber of each container is converted to a pressure substantially equal to the pressure of water in the feed water inlet conduit independently of moving the pistons in the containers.

7. The system of claim 6, wherein the piston in each container has a surface in each of the first and second chambers of the container, the surface in the first chamber having a greater area than the surface in the second chamber.

8. The system of claim 6, wherein the piston in each container has a surface in each of the first and second chambers of the container, the surface in the first chamber having an equal area to the surface of the piston in the second chamber, and further comprising a low pressure water pump disposed between the low pressure water supply and the second chamber of each container and provided to increase the pressure of the low pressure water flowing through the low pressure water inlet port of the containers to create a pressure differential between the first and second chambers of a container.

9. The system of claim 6, wherein the at least one valve assembly includes a plurality of gate valves.

10. The system of claim 6, wherein the at least one valve assembly includes a plurality of check valves.

11. The system of claim 6, further comprising a water accumulator positioned downstream from the high pressure pump and upstream from the reverse osmosis filter apparatus to accommodate fluctuations of pressure of water contained in the feed water inlet conduit.

12. The system of claim 6, comprising a brine outlet conduit coupled to the brine outlet ports of the containers, and including a flow control device located on the brine outlet conduit to control the rate at which the pistons move in the containers.

13. The system of claim 12, wherein the flow control device comprises a needle valve.

14. The system of claim 6, wherein the pistons are mechanically coupled to each other by a shaft so that movement of one piston causes a corresponding movement of the other piston.

15. The system of claim 14, wherein the pistons are mechanically coupled to each other by a single shaft.

16. The system of claim 6, comprising a plurality of pairs of first and second containers, the pairs of first and second container arranged in parallel in the system.

17. The system of claim 6, further comprising a switching assembly operative to control the at least one valve assembly.

18. The system of claim 17, wherein the switching assembly comprises a switch actuated by the movement of at least one piston in one of the containers.

19. The system of claim 17, wherein the switching assembly comprises an electrical switch actuated by the position of a shaft extending from the pistons.

20. A method for filtering water in a reverse osmosis system, comprising the steps of:
(a) directing high pressure water to a reverse osmosis filter apparatus to produce filtered product water and brine;
(b) directing the brine from the reverse osmosis filter apparatus to a pressure conversion apparatus;
(c) directing low pressure water to the pressure conversion apparatus in a manner that the low pressure water does not mix with the brine; and
(d) actuating at least one valve in the reverse osmosis system so that the low pressure water contained in the pressure conversion apparatus is converted to a pressure substantially equal to the high pressure water of step (a) without separately generating a force on the low pressure water.
